(19) United States
(12) Patent Application Publication
(10) Pub. No.: US 2023/0406486 A1
(43) Pub. Date: Dec. 21, 2023

(54) AIRCRAFT LANDING GEAR

(71) Applicant: AIRBUS OPERATIONS LIMITED, Bristol (GB)

(72) Inventors: Fraser WILSON, Bristol (GB); Benjamin BISHOP, Bristol (GB)

(21) Appl. No.: 18/337,897

(22) Filed: Jun. 20, 2023

(30) Foreign Application Priority Data
Jun. 20, 2022 (GB) 2209026.0

(51) Int. Cl. B64C 25/22; B64C 25/62; B64C 25/34

(52) U.S. Cl. CPC B64C 25/22; B64C 25/62; B64C 25/34

(57) ABSTRACT

A trailing link landing gear (6) has a main arm (20) which extends from a proximal end (22) attachable to an aircraft (2) to a distal end (24), and a trailing arm (30) which extends from a pivotable connection at the distal end (24) of the main arm (20) to one or more wheels (39). A shock absorber (40) extends between the main arm (20) and the trailing arm (30). An adjustment member (50) mounted to one of the arms can be moved to move an end of the shock absorber (40) and thereby change the angle that the trailing arm (30) makes with the main arm (20). This, in turn, changes the height of the landing gear (6) and in doing so changes the angle of attack (10) of an aircraft (2) including the landing gear (6).

### RELATED APPLICATION

This application incorporates by reference and claims priority to United Kingdom patent application GB 2209026.0, filed Jun. 20, 2022.

### BACKGROUND OF THE INVENTION

The present disclosure relates to the field of aircraft landing gear, more specifically landing gear of the ‘trailing link’ type. It relates particularly but not exclusively to trailing link landing gear the height of which can be adjusted so as to adjust the angle of attack of aircraft during take-off and/or landing.

Conventional aircraft landing gear often has a shock-absorbing strut known as an oleo strut, which extends vertically downward from the body of the aircraft (for instance from the wing or the fuselage) and supports one or more wheels on its distal end. The oleo strut resiliently compresses under the weight of the aircraft when it is on the ground, as well as resiliently compressing and extending so as to absorb shocks during take-off and landing. The oleo strut is often braced in the fore/aft direction and/or in the inboard/outboard direction by one or more side-stays extending between the strut and the aircraft body.

Another distinct type of known landing gear is trailing link landing gear. In this landing gear, a main arm depends from the body of the aircraft and from its distal end a trailing arm extends generally rearward (i.e. diagonally rearward and backward, straight backward, or diagonally rearward and upward). The distal end of the trailing arm supports one or more wheels. The trailing arm is pivotable relative to the main arm, thereby allowing the wheels thereon to move up and down. A shock absorber is provided, usually extending between the trailing arm and a component on the aircraft body or between the trailing arm and the main arm. Similar to the oleo strut, the shock absorber resiliently compresses under the weight of the aircraft when it is on the ground, and resiliently compresses and extends so as to absorb shocks during take-off and landing.

In some circumstances it is desirable for the height of landing gear, i.e. the distance from the bottom of the wheel(s) to the top of the landing gear, to be adjustable. This can be beneficial, for example in allowing the landing gear to adjust the angle of attack of the aircraft during take-off. This is discussed in more detail later.

Arrangements for adjusting the angle of attack of aircraft using the landing gear are known, but the mechanisms by which this is achieved are relatively complex, bulky, heavy, expensive to manufacture, weak and/or difficult to inspect or service.

The present invention seeks to mitigate at least one of the above disadvantages, and/or to provide an improved or alternative landing gear, aircraft, or method of taking off in an aircraft.

### SUMMARY OF THE INVENTION

According to a first aspect of the present invention there is provided a trailing link landing gear comprising: a main arm with a proximal end configured for connection to the body of an aircraft, and a distal end; a trailing arm pivotally coupled to the distal end of the main arm, the trailing arm having a proximal end, and distal end for supporting one or more wheels; and a shock absorber having a proximal end connected to the main arm and a distal end connected to the trailing arm, the ends of the shock absorber being resiliently movable towards one another so as to damp pivoting of the trailing arm relative to the main arm, wherein an end of the shock absorber is coupled to the corresponding arm via an adjustment member which is movable relative to that arm between first and second positions, said movement of the adjustment member moving said end of the shock absorber relative to said arm and thereby allowing and/or driving the trailing arm to pivot relative to the main arm between corresponding first and second angles.

The adjustment member being movable to change the position of an end of the shock absorber, and thereby drive or allow the trailing arm to pivot, can provide a mechanism for adjusting landing gear height which is advantageously simple, compact, light, inexpensive, strong and/or easy to inspect or service. The landing gear height may be defined as the distance from the bottom of the wheel(s) to the top of the landing gear when the weight of the aircraft is on the wheels of the landing gear (i.e. “weight on wheels”) and the landing gear is in a steady state (i.e. at rest). In a conventional trailing arm landing gear, the rotation of the trailing arm means that the vertical extent of the landing gear varies about the landing gear height when the aircraft is taxiing but the landing gear height (as defined above) remains constant. In contrast, movement of the adjustment member of the present invention between the first and second positions allows the landing gear height to be changed.

Movement of the adjustment member may be considered to drive pivoting of the trailing arm if the trailing arm pivots as a result of movement of the adjustment member, and may be considered to allow pivoting of the trailing arm if the adjustment member moves as a result of pivoting of the trailing arm. Movement of the adjustment member may both drive and allow pivoting of the trailing arm if the adjustment member urges the trailing arm to pivot but the trailing arm is also urged to pivot by another force.

Where movement of the adjustment member drives pivoting of the trailing arm, the adjustment member may move the entire shock absorber so as to drive/allow pivoting of the trailing arm, or may move said end of the shock absorber relative to the other end of the shock absorber (at which point the restorative force from the shock absorber would urge the trailing arm to pivot).

The landing gear may be configured such that when the main arm is connected to the body of an aircraft the trailing arm extends diagonally downwards and rearwards, directly rearwards, or diagonally upwards and rearwards from the distal end of the main arm.

The proximal end of the trailing arm may be pivotally coupled to the distal end of the main arm. As an alternative, a central portion of the trailing arm may be pivotably coupled to the main arm.

The landing gear may be configured whereby said pivoting of the trailing arm can take place with the weight of the aircraft resting on the landing gear.

The adjustment member may be rotatable between the first and second positions.

Rotational movement of the adjustment member may provide an even more advantageously simple, inexpensive and/or strong mechanism by which the height of the landing gear can be adjusted. Instead or as well, rotational movement of the adjustment member may place fewer design constraints on the location and orientation of other components (for instance components arranged to move the adjustment member).

The adjustment member may be rotatable between the first and second positions through at least 45 degrees, for instance at least 60 degrees or at least 75 degrees.

By utilising this relatively large rotational movement of the adjustment member, there is considerable difference in the effect of force exerted on or provided by the adjustment member, depending on its position. This will be discussed in more detail below.

The adjustment member may be rotatable to a third position so as to allow the trailing arm to rotate to a third angle, the second position being between the first and third positions and the second angle being between the first and third angles.

This greater range of movement of the adjustment member can provide a correspondingly greater range of movement of the trailing arm pivoting relative to the main arm.

The adjustment member may be rotatable through at least 30 degrees, for instance at least 45 degrees, at least 60 degrees or at least 75 degrees, between the second and third positions.

As described above in relation to rotation between the first and second positions, by utilising this relatively large rotational movement of the adjustment member between the second and third positions there is considerable difference in the effect of force exerted on or provided by the adjustment member depending on its position.

Optionally: the adjustment member is rotatable about an adjustment member axis and said end of the shock absorber is attached to the adjustment member at an attachment point; and with the adjustment member in one of said positions, when viewed along the adjustment member axis a line intersecting the adjustment member axis and the attachment point intersects a longitudinal axis of the shock absorber at an angle of no less than 50 degrees, for instance no less than 60 degrees or no less than 70 degrees.

With the adjustment member in that position, the relatively steep angle between said line and the longitudinal axis can allow a given force experienced by the shock absorber to exert a relatively high torque on the adjustment member (i.e. urging it to rotate relatively strongly). A force exerted on the shock absorber can thus move the adjustment member relatively easily. Instead or as well, the relatively steep angle can allow a given rotation of the adjustment member to bring about a relatively large movement of the associated end of the shock absorber (which in turn can bring about relatively large pivoting movement of the trailing arm and thus a relatively large change in height of the landing gear). This will be discussed in more detail below.

Optionally: the adjustment member is rotatable about an adjustment member axis and said end of the shock absorber is attached to the adjustment member at an attachment point; and with the adjustment member in one of said positions, when viewed along the adjustment member axis a line intersecting the adjustment member axis and the attachment point intersects a longitudinal axis of the shock absorber at an angle of no more than 40 degrees, for instance no more than 30 degrees or no more than 20 degrees.

With the adjustment member in that position, the relatively shallow angle between said line and the longitudinal axis can allow a given force experienced by the shock absorber to exert a relatively low torque on the adjustment member (i.e. urging it to rotate relatively weakly). The adjustment member can therefore be relatively resistant to being moved by a force exerted on it by the shock absorber. Instead or as well, the relatively shallow angle can allow a given rotation of the adjustment member to bring about a relatively small movement of the associated end of the shock absorber (which in turn can bring about relatively small pivoting movement of the trailing arm and thus a relatively small change in height of the landing gear). This will be discussed in more detail below.

The landing gear may further comprise an adjuster arranged to urge the adjustment member to move.

This can afford more control over the movement of the adjustment member (and thus the change in height of the landing gear).

The adjuster may be configured to urge the adjustment member away from the second position, whereupon moving the adjustment member towards the second position may require a force from the adjuster to be overcome. As one alternative, the adjuster may be configured to selectively urge the adjustment member towards the second position.

Where the adjustment member is rotatable between first, second and third positions, the adjuster may be arranged to urge the adjustment member away from the third position, whereupon moving the adjustment member towards the third position may require a force from the adjuster to be overcome. As one alternative, the adjuster may be configured to selectively urge the adjustment member towards the third position.

The adjuster may comprise a resilient member.

This can allow the adjuster to respond passively to changes in the force experienced by the adjustment member (for instance due to changes in the force exerted on the wheels by the ground). Instead or as well, it can allow the adjuster to respond resiliently to sudden loads placed upon it, in the manner of a shock absorber. Instead or as well, it can allow the adjuster to be cheaper, simpler and/or more lightweight or compact.

The resilient member may be, for example, a coil spring or a gas spring. The resilient member may be provided in conjunction with a damper so as to provide a greater shock-absorbing effect.

The adjuster may comprise an actuator.

This can allow the position of the adjuster to be controlled actively, for instance being placed into predetermined positions at predetermined times by a pilot or by an autonomous control system. Instead or as well, the use of an actuator may allow the position of the adjustment member (and thus of the trailing arm) to be adjusted with minimal changes in the load placed on components of the landing gear (in contrast to an arrangement where the adjustment member can be moved between positions only against the bias of a resilient member, for example).

The actuator may be a linear actuator.

This may allow a relatively large force to be exerted by the adjuster without the need for expensive, complex, heavy and/or bulky gearing mechanisms of the like. Further, when used in conjunction with an adjustment member which rotates between positions, the amount of rotation of the adjustment member, produced by a given displacement of the linear actuator, can vary according to its position.

The linear actuator may be a hydraulic cylinder.

Since most aircraft already have hydraulic systems in place, for instance for control of flight surfaces, the use of a hydraulic cylinder may require relatively little additional equipment to incorporated within the aircraft (thereby saving weight and/or cost).

The adjustment member may comprise a first shaft rotatably supported by the main arm, and a second shaft positioned generally parallel to the first shaft, the attachment point being provided on the second shaft.

This can allow the adjustment member to be advantageously simple, compact, light and/or easily incorporated into landing gear designs without placing excessive design constraints on the locations of other components.

For the avoidance of doubt, reference to the two shafts being parallel is not intended to include their being collinear.

The adjustment member may connect the proximal end of the shock absorber to the main arm.

With the adjustment member so positioned, it is located in an area of the landing gear at which space is at less of a premium. In contrast, if the adjustment member were to connect the distal end of the shock absorber to the trailing arm then it would generally be positioned nearer to the wheels, where less space is generally available. Instead or as well, the adjustment member being positioned further from the wheel may make it less vulnerable to being impacted or obstructed by debris kicked up by the wheels.

The proximal end of the main arm may be configured for pivotable connection to the body of the aircraft so as to allow the landing gear to pivot between stowed and deployed positions.

The landing gear can therefore be stowed during flight so as to make the aircraft more aerodynamic.

For the avoidance of doubt, where landing gear according to the invention is movable between stowed and deployed positions, the relative movements of components described herein apply at least when the landing gear is in the deployed position.

The shock absorber and the adjustment member may form a shock absorbing assembly extending between the main arm and the trailing arm, movement of the adjustment member between said positions changing the length of the shock absorbing assembly.

This may provide a beneficially simple and/or compact mechanism by which the first aspect of the invention can be implemented.

Optionally: the adjustment member is rotatable between the first and second positions about an adjustment member axis; said end of the shock absorber is attached to the adjustment member at an attachment point; the adjustment member is movable between the first and second positions via an intermediate position; and when viewed along the adjustment member axis with the adjustment member in the intermediate position, a longitudinal axis of the shock absorber is substantially parallel to or collinear with a line intersecting the adjustment member axis and the attachment point.

The intermediate position may form the ‘centre’ position of an over-centre mechanism which in turn may be used to avoid excess loading of the adjuster during use.

The landing gear may further comprise an auxiliary actuator configured to move the adjustment member to and/or from the intermediate position, either alone or in conjunction with the adjuster.

The auxiliary actuator can thereby remove the need for the adjuster to move the adjustment member to and/or from the intermediate position, and thus reduce the number of constraints placed on the configuration of the adjuster.

The landing gear may further comprise a stop member, the adjustment member being positioned to abut the stop member when in one of said positions.

The stop member may act as a brace, preventing over-travel of the adjustment member and thereby avoiding excess loading of the adjuster during use.

According to a second aspect of the present invention there is provided a trailing link landing gear comprising: a main arm with a mounting point for attachment to the body of an aircraft; a trailing arm for supporting one or more wheels, the trailing arm being attached to the main arm and constrained for pivoting motion relative thereto; and an adjustment member attached to one of said arms and rotatable between first and second positions relative thereto, wherein: the trailing arm is displaceable by rotation of the adjustment member, displacement of the trailing arm changing the distance between said wheels and the attachment point of the main arm; and the adjustment member is rotatable through at least 45 degrees between the first and second positions.

Rotational movement of the adjustment member may provide an advantageously simple mechanism by which the height of the landing gear can be adjusted, and/or may place relatively few design constraints on the location and orientation of the adjuster. By utilising a relatively large rotational movement of the adjustment member, there is considerable difference in the effect of force exerted on or provided by the adjustment member as discussed in more detail below.

According to a third aspect of the present invention there is provided an aircraft comprising a landing gear according to the first or second aspect of the invention.

Such an aircraft may provide one or more of the advantages discussed above.

All or substantially all of said landing gear may be positioned aft of an aft pressure bulkhead of the aircraft.

This can enable easier integrating of the landing gear into the aircraft, for instance avoiding the landing gear impinging of passenger space or cargo space in front of the aft pressure bulkhead.

All or substantially all of said landing gear may be positioned aft of the aft pressure bulkhead when in the deployed configuration and/or when in the stowed configuration, if applicable.

In aircraft with substantially all said landing gear positioned aft of the aft pressure bulkhead, the moment arm between the wheels of that landing gear and the elevator of the aircraft is relatively short due to the rear wheels being placed so far aft. This makes it relatively difficult for the angle of attack of the aircraft to be changed using the elevator alone. The invention enabling adjustment of the height of the landing gear and therefore of the angle of attack of the aircraft may therefore be of particular benefit.

The aircraft may be of the blended wing body or the flying wing type.

An aircraft may be considered to be of the blended wing body type if there is no clear divide between the wings and the main body (e.g. the passenger compartment). An aircraft may be considered to be of the flying wing type if it has no discernible fuselage.

Such aircraft often do not benefit from ground effect during take-off in the same way as conventional aircraft do. Accordingly, the invention allowing adjustment of the height of the landing gear and thus of the angle of attack may be of particular benefit.

The aircraft may comprise a main landing gear which is a landing gear according to the first or second aspect of the invention, and nose landing gear which is a landing gear according to the first or second aspect of the invention.

Both the nose landing gear and the main landing gear falling within the scope of the first and/or second aspects of the invention may magnify the extent to which one or more of the above advantages are provided. Instead or as well, both landing gear having the features of the first and/or second aspects of the invention may enable a degree of parts interchangeability. Furthermore, both nose and main landing gear being adjustable in height can allow the angle of attack of the aircraft to be changed by the landing gear to a greater extent than would be the case if only one of the landing gear was adjustable.

The main landing gear and the nose landing gear may be substantially the same in structure.

This can increase the extent to which parts are interchangeable between the main landing gear and nose landing gear.

Where the main landing gear and the nose landing gear are substantially the same in structure, they may be substantially identical. Alternatively, there may be one or more minor differences such as a difference in overall size, a slight change in geometry, a different number of wheels supported by the trailing arm, or an adjuster of different type and/or strength.

According to a fourth aspect of the present invention there is provided a method of taking off in an aircraft, the aircraft comprising a landing gear which comprises: a main arm with a proximal end connected to a body of the aircraft, and a distal end; a trailing arm pivotally coupled to the distal end of the main arm, the trailing arm having a proximal end, and a distal end for supporting one or more wheels; a shock absorber having a proximal end connected to the main arm and a distal end connected to the trailing arm, the ends of the shock absorber being resiliently movable towards one another so as damp pivoting of the trailing arm relative to the main arm; and an adjustment member arranged to couple an end of the shock absorber to the corresponding arm, wherein the method comprises: accelerating the aircraft to take-off speed; and moving the adjustment member from a second position to a first position so as to move said end of the shock absorber relative to said arm, thereby allowing and/or driving the trailing arm to pivot relative to the main arm from a second angle to a first angle and thus changing the angle of attack of the aircraft.

The method of operation with which the angle of attack is changed by the landing gear may be advantageously simple and/or utilise a mechanism which is advantageously compact, lightweight, inexpensive to produce, strong and/or easy to inspect or service.

The step of moving the adjustment member may be performed before, during or after the step of accelerating the aircraft.

The adjustment member may be moved to the first position by operating an elevator of the aircraft so as to change the force exerted on the landing gear by the ground.

This can allow the landing gear to adjust and vary the angle of attack of the aircraft without requiring any specific command from the pilot, thereby reducing the burden placed upon them.

The adjustment member may be moved to the first position by an adjuster.

Where the adjustment member is moved to the first position by an adjuster and is moved to the first position by operating an elevator of the aircraft so as to change the force exerted on the landing gear by the ground, the adjuster may be a hydraulic cylinder which is pre-pressurised prior to movement of the adjustment member to the first position.

As an alternative to the adjustment member being moved by an adjuster, where the adjustment member is moved to the first position by operating an elevator of the aircraft so as to change the force exerted on the landing gear by the ground, the adjustment member may be moved to the first position against the action of an adjuster.

It will of course be appreciated that features described in relation to one aspect of the present invention may be incorporated into other aspects of the present invention. For example, a method according to the invention may incorporate any of the features described with reference to the aircraft and/or landing gear of the invention and vice versa. Further, it is to be noted that methods described herein are not intended to be limited to the steps of those methods being performed in the order in which they are recited. It would be readily apparent to the skilled person where steps can, or cannot, be performed in a different order.

### DESCRIPTION OF THE DRAWINGS

Embodiments of the present invention will now be described by way of example only with reference to the accompanying schematic drawings of which:

FIG. 1 shows a side view of an aircraft according to a first embodiment of the invention, resting stationary on the ground;

FIG. 2 shows the aircraft of FIG. 1 about to take off;

FIG. 3 shows a perspective rear view of a landing gear of the aircraft of FIGS. 1 and 2, in a first configuration;

FIG. 4 shows a side view of the landing gear of FIG. 3, in the first configuration;

FIG. 5A shows a linkage diagram of the landing gear of FIGS. 3 and 4, in the first configuration;

FIG. 5B shows a linkage diagram of the landing gear, in a second configuration;

FIG. 5C shows a linkage diagram of the landing gear, in a third configuration;

FIG. 6 shows a perspective rear view of the landing gear in the third configuration;

FIG. 7 shows a side view of the landing gear in the third configuration;

FIG. 8 shows a flow chart of a method of taking off in the aircraft of FIGS. 1 and 2; and

FIG. 9 shows a linkage diagram of a landing gear according to a second embodiment of the invention, in a first configuration.

### DETAILED DESCRIPTION

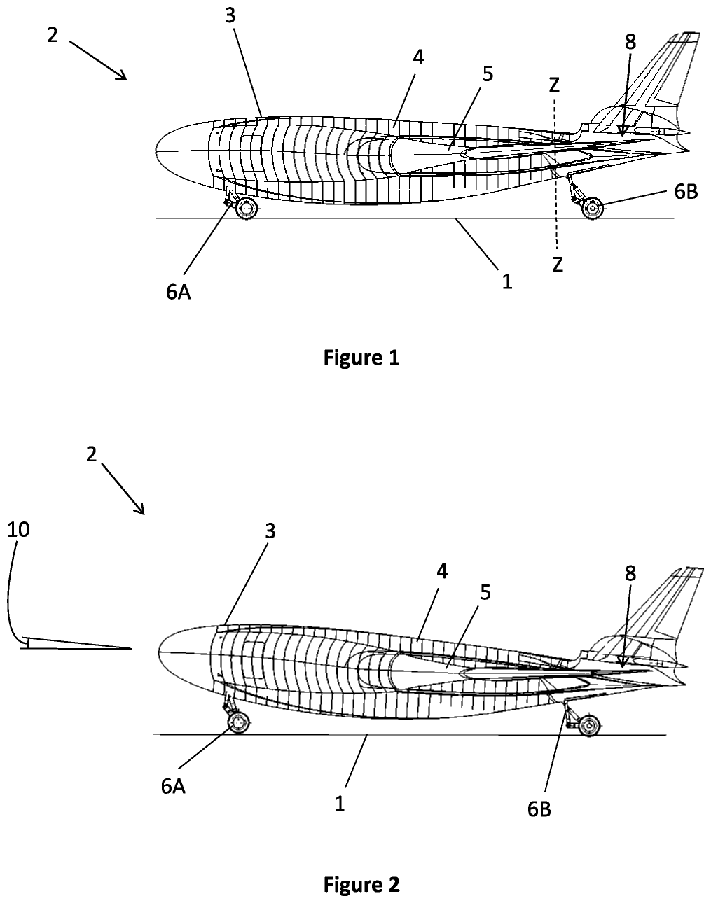

FIG. 1 shows an aircraft 2 according to a first embodiment of the invention, at rest on the ground 1. The aircraft has a body 3 which includes a fuselage 4 and a pair of wings 5 blended thereto so as to form an aircraft of the blended wing body type. The aircraft 2 has a total of three landing gear 6, a nose landing gear 6A and two main landing gear 6B (one of which is visible in FIG. 1). The nose landing gear 6A and each of the main landing gear 6B are substantially the same in structure, with a single component being different as discussed later.

For safety reasons, the main landing gear 6B is positioned aft of the aft pressure bulkhead of the aircraft. The aft pressure bulkhead is not visible in FIG. 1, but its location in the fore-aft direction is denoted by line Z-Z. This positioning of the main landing gear 6B means that it is further away from the centre of mass of the aircraft and closer to the elevator 8 than is the case for conventional designs.

To take off in conventional aircraft, once the aircraft is moving with sufficient speed the elevator is raised so as to urge the rear of the aircraft down. This creates a moment which pivots the nose of the aircraft upward about the wheels of the main landing gear, changing the angle of attack of the aircraft and providing enough lift to take the aircraft airborne. However, in the aircraft 2 of this embodiment the main landing gear 6B being so far away from the centre of mass means that the moment produced by weight of the aircraft 2, acting to keep it level, is particularly large. Similarly, the main landing gear 6B being so close to the elevator 8 means that and the moment produced by the elevator 8, acting to pivot the nose of the aircraft 2 upwards, is particularly small.

The aircraft 2 of this embodiment is of the blended wing body type. Due to the different aerodynamics at play in this design, the aircraft 2 does not benefit from ground effect in the same way as a conventional aircraft does. Indeed, whereas in conventional aircraft ground effect increases lift and decreases drag, in the aircraft 2 of the present embodiment ground effect actually decreases lift by ‘sucking’ the aircraft 2 downward.

Due to the unusually large moment acting to keep the aircraft level, and the reduced lift caused by the ground effect, the aircraft 2 of this embodiment is unable to take off in conventional fashion. Accordingly, for the aircraft 2 to take off the angle of attack is adjusted by changing the height of the landing gear 6, as shown in FIG. 2.

As shown in FIG. 2, the angle of attack 10 has been increased to around 10 degrees by extending the nose landing gear 6A (i.e. increasing its height) and shortening the main landing gear 6B (i.e. reducing its height). This angle of attack 10 is sufficient to allow the aircraft 2 to break free of the ground effect and take off.

With the main landing gear 6B positioned relatively far rearward on the aircraft 2, the weight distribution across the landing gear 6A, 6B is such that the three landing gear each bear approximately equal portions of the weight of the aircraft 2, whereas in a more conventional design around 95% of the weight of an aircraft is taken by the two main landing gear and only 5% is taken by the nose landing gear. The equal load share between the nose landing gear 6A and each of the main landing gear 6B can mean that it is particularly practical for them to be substantially the same in structure as one another, as discussed above. In contrast, in were this the case in a more conventional design then the nose landing gear would likely be considerably larger and heavier than would be appropriate for the loads it would experience.

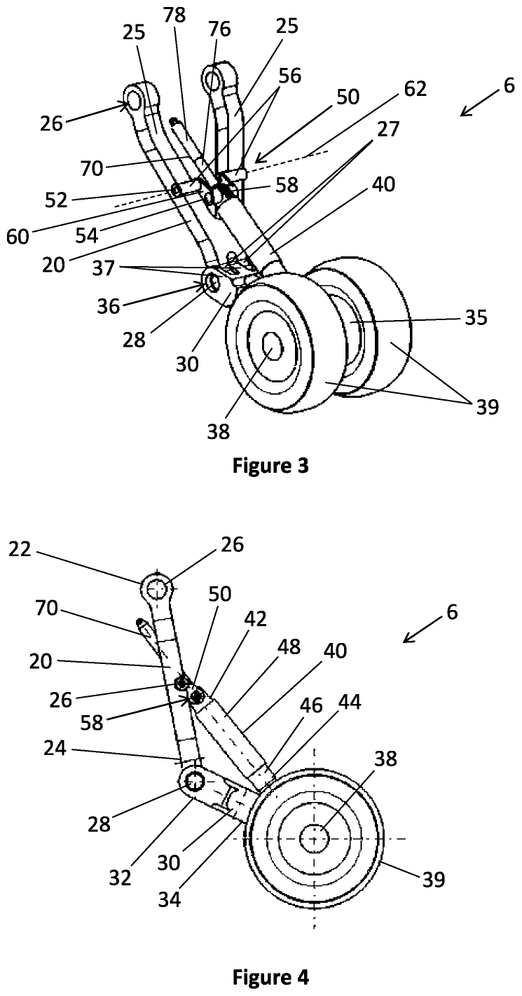

One of the landing gear 6 of the aircraft 2 is shown in FIGS. 3 and 4. The nose landing gear 6A and main landing gear 6B are visually identical, therefore the landing gear 6 shown in FIGS. 3 and 4 could be either a nose landing gear 6A or a main landing gear 6B.

The landing gear 6 has a main arm 20 which extends from a proximal end 22 to a distal end 24. The main arm 20 is forked at its proximal end 22, with two tines 25 that converge and combine towards the distal end 24. The proximal end 22 of the main arm 20 has a mounting point in the form of a through bore 26 which passes through both tines 25 and is shaped to receive a shaft (not visible) by which the main arm 20 (and thus the landing gear 6 as a whole) is connected to the body 3 of the aircraft 2. Thus, the tines 25 form the landing gear side of the main pintle of the landing gear. The distal end 24 of the main arm 20 has a pair of flanges 27 supporting a stub shaft 28.

The main arm 20 can pivot rearwards and upwards around the axis of rotation defined by the main pintle so as to allow the landing gear 6 to pivot between a deployed position (as shown in FIGS. 1 and 2) and a stowed position. The mechanism by which the landing gear 6 can be moved between these positions is not material to the present invention. Accordingly, discussion of this mechanism will be omitted and the landing gear will be discussed in relation to its structure and function when in the deployed position.

The landing gear 6 also has a trailing arm 30 which extends from a proximal end 32 to a distal end 34. The proximal end 32 has a set of three flanges 37 which are spaced apart to accommodate the flanges 27 of the main arm 20 interleaved therebetween, and have a through bore 36 which rotatably receives the stub shaft 28. The flanges 27, 37 and the stub shaft 28 form a hinge joint which pivotally couples the trailing arm 30 to the main arm 20. The distal end 34 of the trailing arm 30 has an enlarged portion 35 which supports a bearing assembly (not visible) and an axle 38 upon which two wheels 39 are rotatably mounted.

The landing gear 6 also has a shock absorber 40 extending from a proximal end 42 to a distal end 44. Each end 42, 44 of the shock absorber is mounted to a respective one of the arms 20, 30. The proximal end 42 of the shock absorber 40 is mounted to the main arm around half way along the length of the main arm 20, and the distal end 44 of the shock absorber 40 is mounted to the trailing arm 30 towards the distal end 34 thereof. The proximal end 42 of the shock absorber 40 is connected to the main arm 20 by an adjustment member 50, as described in more detail below, and the distal end 44 of the shock absorber is connected directly to the trailing arm 30. The connection between the proximal end 42 of the shock absorber 40 and the main arm 20 is pivotable, as is the connection between the distal end 44 of the shock absorber 40 and the trailing arm 30.

The shock absorber 40 has an inner portion 46 telescopically received within an outer portion 48. The inner and outer portions 46, 48 are connected to one another via a gas spring (not visible) and a hydraulic damper (not visible) such that the ends 42, 44 of the shock absorber 40 are biased to a default position but can be disturbed therefrom by an external axial force. Such a force would move the ends 42, 44 of the shock absorber towards one another (in the case of a compressive force) or away from one another (in the case of a tensile force), against the bias of the gas spring. The bias of the gas spring (not visible) would resiliently oppose this movement due to the change in pressure of the gas therein, and the hydraulic damper (not visible) would oppose the movement via viscous friction, as is well known in the art.

With the trailing arm 30 being pivotable relative to the main arm 20 and both ends 42, 44 of the shock absorber 40 being pivotable relative to the respective arms 20, 30 to which they are connected, resilient deformation of the shock absorber 40 (i.e. movement of the ends 42, 44 of the shock absorber 40 towards or away from one another) allows pivoting of the trailing arm 30 relative to the main arm 20 without undue stress at any of the connections therebetween. Thus, the landing gear 6 provides the aircraft 2 with a suspension system. With the wheels 39 on the ground 1, the weight of the aircraft 2 compresses the shock absorber 40 (and thus pivots the trailing arm 30 upwards) to some extent. As the aircraft travels along a runway, for instance during take-off and landing, bumps and undulations in the runway can be accommodated by compression/extension of the shock absorber 40 allowing associated small pivoting movements of the trailing arm 30.

As noted previously, the proximal end 42 of the shock absorber 40 is attached to the main arm 20 by an adjustment member 50. The shock absorber 40 and adjustment member 50 form a shock absorbing assembly 51 which extends between the main arm 20 and the trailing arm 30. The adjustment member 50 has a first shaft 52 attached to the main arm 20 and a second shaft 54 attached to the shock absorber 40. The first shaft 52 has two axial sections, each received in a corresponding sleeve 56 fixed to a respective tine 25 of the main arm 20. The second shaft 54 is aligned parallel to the first shaft 52, and is located axially between the two sections of the first shaft 52. The second shaft 54 extends through the proximal end 42 of the shock absorber 44, forming the attachment point 58 via which the shock absorber 40 is connected to adjustment member 50 and thus to the main arm 20. A pair of connecting arms 60 join the two shafts 52, 54 together, and act as spacers to keep the end 42 of the shock absorber 40 centred on the second shaft 54.

The first shaft 52 is rotatably received within the sleeves 56 such that the adjustment member 50 is rotatable relative to the main arm 20 about an adjustment member axis 62 defined by the first shaft 52. Similarly, the second shaft 54 is rotatably received within the proximal end 42 of the shock absorber, therefore the attachment point 58 allows pivoting movement of the shock absorber 40 and adjustment member 50 relative to one another.

Also connected to the adjustment member 50 is an adjuster 70. The adjuster 70 extends from a proximal end 72 connected to the body 3 of the aircraft 2, to a distal end 74 pivotally connected to the second shaft 54 of the adjustment member 50. Like the shock absorber 40, the adjuster 70 has an inner portion 76 telescopically received within an outer portion 78 to allow the ends 72, 74 of the adjuster 70 to move towards and away from one another.

The adjuster 70 is the component mentioned above which differs between the nose landing gear 6A and the main landing gear 6B. In the case of the nose landing gear 6A the outer portion 78 is the barrel of a hydraulic cylinder and the inner portion 76 is the piston rod. In the case of the main landing gear 6B the inner and outer portions 78, 76 are sealed against one another with a quantity of gas trapped inside the outer portion 76 so as to form another gas spring.

In both cases, the ends 72, 74 of the adjuster 70 are movable towards and away from one another by moving the inner portion 78 relative to the outer portion 76. In the case of the nose landing gear 6A the inner portion can be moved by feeding hydraulic fluid in front of or behind a piston head (not visible) attached to the inner portion 78. In the case of the main landing gear 6B the inner and outer portions 78, 76 can be moved by external force, against the bias of the gas spring mechanism formed thereby.

In either case, the proximal end 72 of the adjuster is held fixed, therefore movement of the ends 72, 74 of the adjuster 70 towards or away from one another allows the second shaft 54 to move, and thus allows the adjustment member 50 to rotate about the adjustment member axis 62. Rotation of the adjustment member 50 allows the attachment point 58 (on the second shaft 52) to move and thus allows the proximal end 42 of the shock absorber 40 to move. Under normal load conditions the distal end 44 of the shock absorber 40 follows the proximal end 42 (potentially accompanied by some degree of deformation of the shock absorber 40). The length of the shock absorbing assembly 51 (i.e. the distance through which it extends between the main arm 20 and the trailing arm 30) therefore changes. The trailing arm 30, attached to the distal end 44 of the shock absorber 40, moves with the distal end 44 and thus the trailing arm 30 is displaced and pivots relative to the main arm 20, changing the angle therebetween. This has the effect of moving the wheels 39 up or down, changing the height of the landing gear 6.

FIGS. 3 and 4 show the landing gear 6 in a first configuration, in which the adjustment member 50 is in a first position and the trailing arm 30 is at a first angle relative to the main arm 20. The landing gear 6 is at its tallest when in the first configuration. By moving the adjustment member 50 by rotating it (anticlockwise from the perspective of FIGS. 3 and 4) about adjustment member axis 62, shortening the length of the shock absorbing assembly 51 and displacing the trailing arm 30 by pivoting it upwards to form a second angle with the main arm 20, the landing gear can be placed into a second configuration. The landing gear 60 is shorter in the second configuration than in the first configuration. Through further rotation of the adjustment member 50 to a third position (thus further shortening the shock absorbing assembly 51 and further pivoting displacement of the trailing arm 30 to form a third angle with the main arm 20), the landing gear 6 can be placed into a third configuration. The landing gear 6 is at its shortest when in the third configuration.

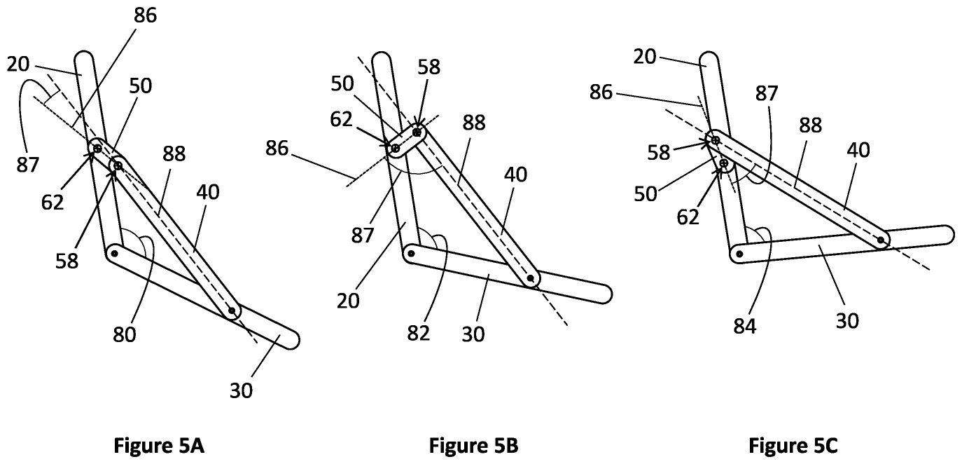

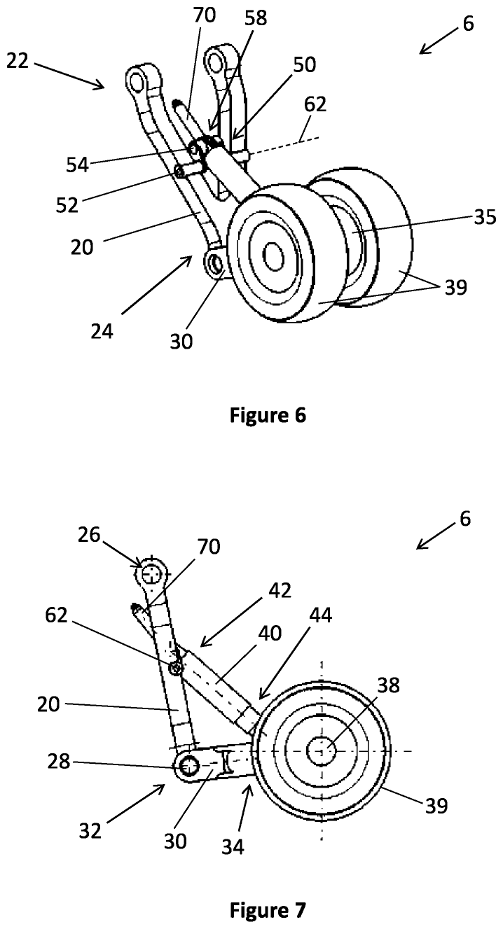

FIGS. 5A, 5B and 5C illustrate the relative positions of the components of the landing gear 6 in the first, second and third configurations respectively, illustrating the first angle 80, second angle 82 and third angle 84 discussed above. FIGS. 6 and 7 show the landing gear 6 in the third configuration.

The range of motion of the adjustment member 50 between the first and second positions, and between the second and third positions, is relatively high. More specifically, in this embodiment the adjustment member 50 is rotatable through around 85 degrees between the first and second positions, and is rotatable through around 65 degrees between the second and third positions. This relatively large range of motion allows the effect that forces exerted on the adjustment member 50 by the shock absorber 40, and/or the effect that rotation of the adjustment member 50 has on movement of the shock absorber 40, to vary considerably according to the position that the adjustment member 50 is in.

For instance, as shown in FIG. 5A, with the landing gear 6 in the first configuration (i.e. with the adjustment member 50 in the first position), a line 86 intersecting the adjustment member axis 62 and the attachment point 58 intersects the longitudinal axis 88 of the shock absorber 40 at an angle 87 of around 5 degrees. Accordingly, any axial force experienced by the shock absorber 40 has a relatively small vector component in the direction of movement of the attachment point 58 (which is constrained by the adjustment member 50 to move around the adjustment member axis 62). Thus, with the adjustment member 50 in the first position an axial force exerted on the adjustment member 50 by the shock absorber 40 produces relatively little torque on the adjustment member 50. In other words, the effect that axial forces experienced by the shock absorber 40 have on the adjustment member 50 is relatively small.

Equally, rotation of the adjustment member 50 when in the first position would move the attachment point 58 in a direction with a relatively small vector component in the direction of the longitudinal axis 88 of the shock absorber 40. Thus, rotation of the adjustment member 50 would bring about relatively little axial movement of the shock absorber 40 (and therefore relatively little change in length of the shock absorbing assembly 51), thereby bringing about relatively little change in height of the landing gear 6.

In contrast, as shown in FIG. 5B, with the adjustment member 50 in the second position (i.e. the landing gear 6 in the second configuration) the line 86 intersecting the adjustment member axis 62 and the attachment point 58 intersects the longitudinal axis 88 of the shock absorber 40 at an angle 87 of around 90 degrees. Accordingly, any axial force experienced by the shock absorber 40 has a relatively large vector component in the direction of movement of the attachment point 58. Thus, with the adjustment member 50 in the second position, an axial force exerted on the adjustment member 50 by the shock absorber 40 would exert a relatively high torque on the adjustment member 50. Equally, rotation of the adjustment member 50 when in the second position would move the attachment point 58 in a direction with a relatively large vector component in the direction of the longitudinal axis 88 of the shock absorber 40. Thus, rotation of the adjustment member 50 would bring about a relatively large change in the length of the shock absorbing assembly 51 and relatively great axial movement of the shock absorber 40.

As shown in FIG. 5C, with the landing gear 6 in the third configuration (i.e. with the adjustment member 50 in the third position), the line 86 intersecting the adjustment member axis 62 and the attachment point 58 intersects the longitudinal axis 88 of the shock absorber 40 at an angle 87 of around 25 degrees. Again, therefore, any axial force experienced by the shock absorber 40 has a small vector component in the direction of movement of the attachment point 58. Accordingly, as was the case with the adjustment member 50 in the first position, with the adjustment member 50 in the third position an axial force exerted on the adjustment member 50 by the shock absorber 40 produces relatively little torque on the adjustment member 50, and equally rotation of the adjustment member 50 would bring about relatively little axial movement of the shock absorber 40.

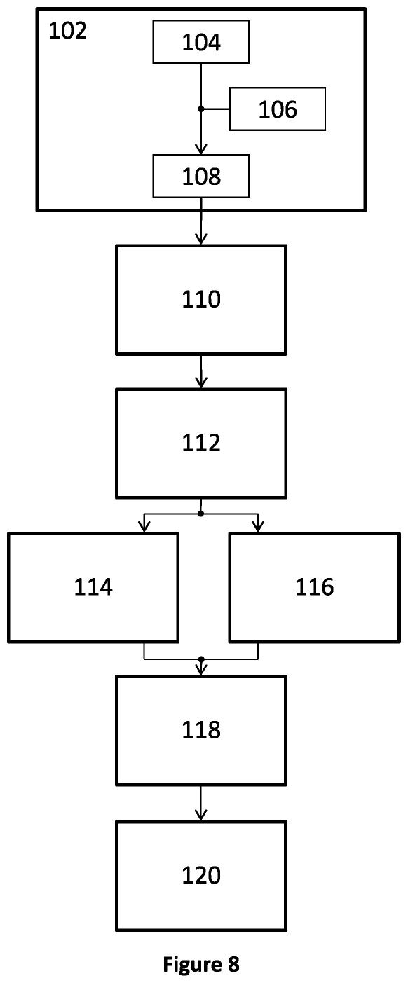

As noted above, the different heights to which the landing gear 6 can be adjusted, based on the position of the adjustment member 50, can assist the aircraft 2 during take-off and/or landing. This is outlined below, with reference to FIG. 8 in combination with FIGS. 1 to 7, in respect of one exemplary method of use of the aircraft 2.

When the aircraft 2 is ready to take off, its pilot engages 102 a pre-take-off mode of the aircraft 2, which ensures that the nose landing gear 6A and main landing gear 6B are each in the second configuration (as shown in FIG. 1). As noted above, the adjuster 70 of each main landing gear forms a gas spring. The main landing gear 6B are therefore not actively controlled. Instead, spring constant of the gas springs 70 is selected such that with the weight of the aircraft and its cargo distributed correctly, the compressive load borne by each of the main landing gear 6B acts through the shock absorber 40 (which is itself compressed to some extent) and rotates the adjustment member 50 to the second position. In the case of the nose landing gear 6A, however, the adjuster 70 is a hydraulic cylinder and is therefore actively controlled. Once the pilot engages the pre-take-off mode an automatic control system checks 104 that the cylinder 70 is extended to the correct length for the adjustment member 50 to be in the second position, and if necessary controls 106 a set of valves and a hydraulic pump (not visible) so as to move the adjuster 70 until the adjustment member 50 is so positioned.

In other embodiments the automatic control system then controls the valves so as to lock the adjuster 70 in this position. In this embodiment, however, the control system pre-pressurises 108 the adjuster 70 by filling a hydraulic accumulator (not visible) that is connected to the adjuster 70 and opening valves therebetween. The accumulator is filled with hydraulic fluid to the pressure at which the torque exerted on the adjustment member 50 by the adjuster 70 is equal to the torque exerted on the adjustment member 50 in the opposite direction by the shock absorber (due to the force of the ground 1 on the wheels 39). The adjustment member 50 therefore remains in the second position. The aircraft is then in the position shown in FIG. 1.

At this point, the pilot accelerates 110 the aircraft 2 to take-off speed with the landing gear 6A, 6B each in the second configuration, and then raises 112 the elevator 8. The elevator 8 urges the aircraft 2 to pivot backwards, but as noted above the moment produced by the elevator 8 is insufficient to adequately change the angle of attack 10. However, the force from the elevator 8 does reduce the load experienced by the nose landing gear 6A and increase the load experienced by each of the main landing gear 6B.

With the load experienced by the nose landing gear 6A reduced, the force exerted on the adjustment member 50 by the shock absorber 40 is reduced. The force applied by the pre-pressurised cylinder 70 remains unchanged, however, therefore the adjustment member 50 is rotated 114 out of the second position and to the first position. The rotation of the adjustment member drives the trailing arm 30 to pivot downwards, which increases the height of the landing gear 6A as explained above.

Meanwhile, with each main landing gear 6B experiencing a greater load, its shock absorber 40 experiences greater load and transmits this to the adjustment member 50. The torque exerted on the adjustment member 50 via its shock absorber 40 therefore increases. The force exerted by its gas spring 70, and the resulting torque therefrom, remains the same. The adjustment member 50 is therefore rotated 116 against the bias of the gas spring out of the second position and to the third position. This rotation of the adjustment member 50 allows the trailing arm 30 to pivot upward due to the ground reaction force exerted on the wheels 39. The height of each main landing gear 6B is therefore reduced.

It is noteworthy that with the landing gear 6A, 6B in the second configuration, forces applied to the adjustment member 50 by the shock absorber 40 create a relatively high torque, and rotation of the adjustment member 50 creates relatively great movement of the proximal end 42 of the shock absorber 40, as discussed above. Thus, the landing gear 6A, 6B are particularly responsive with the adjustment member 50 in this position. As the adjustment member 50 of the nose landing gear 6A starts to move under action of the adjuster 70, the proximal end 42 of the shock absorber 40 is moved through a relatively great distance and thus the height of the landing gear 6A changes relatively rapidly. Similarly, as the load on each main landing gear 6B begins to increase and the force applied by the shock absorber 40 increases, this increase in force brings about a relatively large increase in torque exerted on the adjustment member 50 and thus the adjustment member rotates relatively quickly (and through a relatively large angle as the gas spring 70 compresses). Again, therefore, the height of the landing gear 6B changes relatively rapidly.

With the nose landing gear 6A increased in height to the first configuration and both main landing gear 6B reduced in height to the third configuration, the angle of attack of the aircraft 2 is increased to around 10 degrees as illustrated in FIG. 2. The aircraft 2 can then break free of the ground effect sufficiently for the aircraft 2 to rise 118. As the aircraft 2 rises, the wheels 39 of the nose landing gear 6A lift from the ground and the load experienced by the main landing gear 6B reduces. The main landing gear 6B therefore move from the third configuration to the second configuration and then to the first configuration as the aircraft 2 rises, under action of the gas springs 70. The aircraft 2 then continues to rise, the wheels 39 of the main landing gear 6B lift from the ground 1 and the aircraft 2 becomes airborne 120.

It is noteworthy that with the landing gear 6A, 6B in the first and third configurations respectively, forces applied to the adjustment member 50 by the shock absorber 40 create a relatively low high torque, and rotation of the adjustment member 50 creates relatively little movement of the proximal end 42 of the shock absorber 40, as discussed above. Thus, the landing gear 6A, 6B are less responsive and consequently less likely to be disturbed in a manner which would reduce the angle of attack 10. If the nose landing gear 6A were to hit a bump in the runway, the relatively low torque exerted on the adjustment member 50 by the force of the bump (exerted via the shock absorber 40) would likely be insufficient to move the adjustment member 50 back towards the second position against the force of the adjuster 70. Similarly, if one of the main landing gear 6A were to ride over a depression in the runway, the reduced load applied via the shock absorber 40 may cause the adjustment member 50 to rotate slightly but this would have little effect on the vertical height of the proximal end 42 of the shock absorber 40 (and thus little effect on the height of the landing gear 6B).

Landing the aircraft 2 follows the reverse of the take-off process. As the aircraft 2 approaches the runway, with no load on the landing gear 6A, 6B, the nose landing gear 6A is held in the first configuration by the pressurised hydraulic cylinder 70 and the main landing gear 6B are held in the first configuration by their respective gas springs. As the aircraft descends at an angle of attack 10 of around 10 degrees, the wheels 39 of the main landing gear 6B contact the ground 1. As the aircraft 2 descends further, the load experienced by the main landing gear 6B increases and the main landing gear are moved from the first configuration to the second configuration and then to the third configuration, with rotation of their respective adjustment couplings allowing this movement by rotating against the bias of their respective adjusters 70.

As both the main landing gear 6B reach the third configuration, the wheels 39 of the nose landing gear 6A contact the ground 1. The aircraft 2 is then in the position shown in FIG. 2 once again. At this point the air brakes of the aircraft 2 are deployed so as to slow it down, and as the aircraft 2 decelerates the load on the nose landing gear 6A is increased and the load on the main landing gear 6B is reduced. The increased load on the nose landing gear 6A is sufficient to force the hydraulic cylinder 70 to contract, forcing hydraulic fluid back into the accumulator and rotating the adjustment member 50 so as to allow the trailing arm 30 to pivot upwards and move the landing gear 6A to the second configuration. Similarly, the reduced load on the main landing gear 6B allows them to return to the second configuration, with their respective gas springs 70 rotating their adjustment members 50 and thereby driving the trailing arms 30 to pivot downwards.

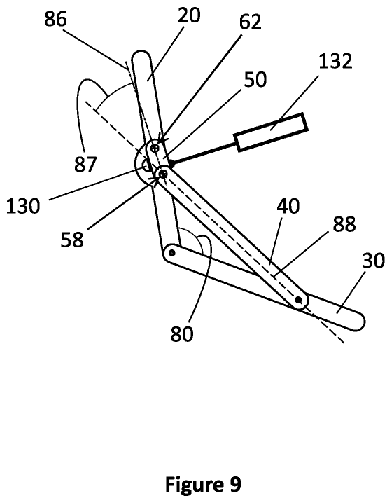

FIG. 9 illustrates a landing gear 6 according to a second embodiment of the invention. The second embodiment is a modification of the first embodiment, therefore only the differences will be described here.

The landing gear 6 of this embodiment has a pair of stop members 130 (one of which is visible in FIG. 9) which project inward towards one another from each tine (not visible) of the main arm 20, and an auxiliary actuator 132 in the form of a further hydraulic cylinder arranged to rotate the adjustment member 50. With the landing gear 6 of this embodiment in the first configuration, the adjustment member 50 abuts the stop members 130. The stop members 130 prevent over-travel of the adjustment member 50 beyond the first position (i.e. anticlockwise from the perspective of FIG. 9).

In this embodiment, the adjustment member 50 moves between the first position and the second position via an intermediate position. With the adjustment member 50 in the intermediate position, when viewed along the adjustment member axis 62 the line 86 intersecting the adjustment member axis 62 and the attachment point 58 is collinear with the longitudinal axis 88 of the shock absorber 40.

The intermediate position forms the ‘centre’ position of an over-centre mechanism —movement of the adjustment member 50 from the second position to the intermediate position requires extension of the adjuster (not visible), but movement of the adjustment member 50 from the intermediate position to the first position requires contraction of the adjuster (not visible). Similarly, movement of the adjustment member 50 from the first position to the intermediate position requires extension of the adjuster (not visible), but movement of the adjustment member 50 from the intermediate position to the second position requires contraction of the adjuster.

Accordingly, if loading on the trailing arm 30 were to urge it to rotate upward, this would urge the adjustment member 50 to move towards the first position if it were in a position between the first position and the intermediate position, or would urge the adjustment member 50 to move towards the second position if it were in a position between the intermediate position and the second position

This, in turn, means that if the landing gear 6 were loaded in the first configuration as shown in FIG. 9, the adjustment member 50 would be held against the stop surfaces 130. The stop surfaces 130 prevent the adjustment member 50 from rotating any further (which would move the landing gear 6 out of the first configuration), meaning that the adjuster (not shown) does not need to be strong enough to perform this task. The adjuster (not shown) may therefore be weaker and thus lighter and cheaper, for example.

In this embodiment the adjuster (not shown) is positioned collinear with the longitudinal axis 88 of the shock absorber 40 (and thus with line 86) when the adjustment member 50 is in the intermediate position. With the adjuster so positioned, it is more difficult for the adjuster to reliably control which direction the adjustment member 50 moves in. The auxiliary actuator 132 therefore assists with movement of the adjustment member 50 to and from the intermediate position, in conjunction with the adjuster (not visible) when the adjustment member is at or near the intermediate position.

Another difference between the first and second embodiments is that in the second embodiment the height of the landing gear 6 is actively controlled by the pilot using the adjuster (not shown) and auxiliary actuator 132 (rather than passively controlled using the elevator and a pre-pressurised hydraulic cylinder in the case of the first embodiment). The cockpit of the aircraft has a sliding control by which the pilot manually adjusts the angle of attack of the aircraft during take-off. The sliding control is linked to a hydraulic control unit which controls the flow of hydraulic fluid to the adjuster (not shown) and auxiliary actuator 132 so as to move the adjustment member 50 and change the height of the landing gear 6.

Whilst the present invention has been described and illustrated with reference to particular embodiments, it will be appreciated by those of ordinary skill in the art that the invention lends itself to many different variations not specifically illustrated herein. By way of example only, in other embodiments the adjustment member may be a carriage movable linearly along the length of the main arm. As another example, in other embodiments the landing gear may comprise an adjuster in the form of an electric linear actuator or a mechanical coil spring.

As a further example, whilst the shock absorber of the above embodiment included a gas spring and a hydraulic damper in combination, any other suitable shock absorber may be used. For instance, in some other embodiments the shock absorber may include an electromagnetic damper, a coil spring and/or a deformable elastomeric block instead of or as well as the gas spring and/or the hydraulic damper. In other embodiments there may be little or no damping provided. For example, the shock absorber may consist essentially of a spring such as a gas spring or a coil spring.

As a further example, whilst in the above embodiment the pivotal connection between the main arm and trailing arm was formed by interleaved flanges and a stub shaft, any other suitable connection may be used. For instance, a hinge joint may be formed in a different fashion (for example with one of the arms comprising a pivot shaft received in a corresponding recess in the other arm), or the arms may form a ball and socket joint, ellipsoid joint or saddle joint.

For the avoidance of doubt, reference to the first, second and third positions, angles and configurations should not be construed as limiting. It may equally be considered, for example, that the configuration shown in FIG. 5A is a third configuration and the configuration shown in FIG. 5C is a first configuration. As another example, the configuration shown in FIG. 5B may be considered to be a first configuration and the configuration shown in FIG. 5C may be considered to be a second configuration.

Furthermore, it is to be understood that movement of an adjustment member between positions may be considered to allow pivoting of a trailing arm between respective angles whether the landing gear is under load (e.g. with the shock absorber compressed) or not. For sake of example if a landing gear is considered to be in a first configuration when not under load, and is then put under load (whereupon the angle of the trailing arm may change due to deformation of the shock absorber), the landing gear may nonetheless to be considered to still be in the first configuration.

Where in the foregoing description, integers or elements are mentioned which have known, obvious or foreseeable equivalents, then such equivalents are herein incorporated as if individually set forth. Reference should be made to the claims for determining the true scope of the present invention, which should be construed so as to encompass any such equivalents. It will also be appreciated by the reader that integers or features of the invention that are described as preferable, advantageous, convenient or the like are optional and do not limit the scope of the independent claims. Moreover, it is to be understood that such optional integers or features, whilst of possible benefit in some embodiments of the invention, may not be desirable, and may therefore be absent, in other embodiments.

The term ‘or’ shall be interpreted as ‘and/or’ unless the context requires otherwise.

1. A trailing link landing gear comprising:
a main arm with a proximal end configured to connect to a body of an aircraft, and a distal end;
a trailing arm pivotally coupled to the distal end of the main arm, the trailing arm having a proximal end and distal end configured to support one or more wheels; and
a shock absorber having a proximal end connected to the main arm and a distal end connected to the trailing arm, the ends of the shock absorber being resiliently movable towards one another so as to damp pivoting of the trailing arm relative to the main arm,
wherein an end of the shock absorber is coupled to the corresponding arm via an adjustment member which is movable relative to that arm between first and second positions, said movement of the adjustment member moving said end of the shock absorber relative to said arm and thereby allowing and/or driving the trailing arm to pivot relative to the main arm between corresponding first and second angles.

2. The trailing link landing gear according to claim 1, wherein the adjustment member is rotatable between the first and second positions.

3. The trailing link landing gear according to claim 2, wherein the adjustment member is rotatable between the first and second positions through at least 45 degrees.

4. The trailing link landing gear according to claim 3, wherein the adjustment member is rotatable between the first and second positions through at least 60 degrees.

5. The trailing link landing gear according to claim 3, wherein the adjustment member is rotatable to a third position so as to allow the trailing arm to rotate to a third angle, the second position being between the first and third positions and the second angle being between the first and third angles.

6. The trailing link landing gear according to claim 5 wherein the adjustment member is rotatable through at least 45 degrees between the second and third positions

7. The trailing link landing gear according to claim 2, wherein:
the adjustment member is rotatable about an adjustment member axis and said end of the shock absorber is attached to the adjustment member at an attachment point; and
with the adjustment member in one of said positions, when viewed along the adjustment member axis a line intersecting the adjustment member axis and the attachment point intersects a longitudinal axis of the shock absorber at an angle of no less than 60 degrees.

8. The trailing link landing gear according to claim 1, wherein:
the adjustment member is rotatable about an adjustment member axis and said end of the shock absorber is attached to the adjustment member at an attachment point; and
with the adjustment member in one of said positions, when viewed along the adjustment member axis a line intersecting the adjustment member axis and the attachment point intersects a longitudinal axis of the shock absorber at an angle of no more than 30 degrees.

9. The trailing link landing gear according to claim 1, further comprising an adjuster arranged to urge the adjustment member to move.

10. The trailing link landing gear according to claim 1, wherein the adjuster comprises a resilient member.

11. The trailing link landing gear according to claim 1, wherein the adjuster comprises an actuator.

12. The trailing link landing gear according to claim 11 wherein the linear actuator is a hydraulic cylinder.

13. The trailing link landing gear according to claim 1, wherein the adjustment member comprises a first shaft rotatably supported by the main arm, and a second shaft positioned generally parallel to the first shaft, the attachment point being provided on the second shaft.

14. The trailing link landing gear according to claim 1, wherein the adjustment member connects the proximal end of the shock absorber to the main arm.

15. The trailing link landing gear according to claim 1, wherein the proximal end of the main arm is configured for pivotable connection to the body of the aircraft so as to allow the landing gear to pivot between stowed and deployed positions.

16. The trailing link landing gear according to claim 1, wherein the shock absorber and the adjustment member form a shock absorbing assembly extending between the main arm and the trailing arm, movement of the adjustment member between said positions changing the length of the shock absorbing assembly.

17. A trailing link landing gear comprising:
a main arm with a mounting point configured to attach to a body of an aircraft;
a trailing arm configured to support one or more wheels, the trailing arm being attached to the main arm and constrained for pivoting motion relative thereto; and
an adjustment member attached to one of said main arm and said trailing arm, and the adjustment member is rotatable between a first position and a second position,
wherein the trailing arm is displaceable by rotation of the adjustment member, and displacement of the trailing arm changes a distance between said one or more wheels and the mounting point of the main arm;
wherein the adjustment member is rotatable through at least 45 degrees between the first position and the second position.

18. An aircraft comprising the trailing link landing gear according to claim 1.

19. The aircraft according to claim 18, wherein substantially all of said landing gear is positioned aft of an aft pressure bulkhead of the aircraft.

20. The aircraft according to claim 18, wherein the aircraft has a blended wing body or is a flying wing.

21. The aircraft according to claim 18, wherein the aircraft comprises a main landing gear.

22. The aircraft according to claim 21, wherein the main landing gear and the nose landing gear are substantially the same in structure.

23. A method of taking off in an aircraft, the aircraft comprising a landing gear which comprises:
a main arm with a proximal end connected to a body of the aircraft, and a distal end;
a trailing arm pivotally coupled to the distal end of the main arm, the trailing arm having a proximal end, and a distal end for supporting one or more wheels;
a shock absorber having a proximal end connected to the main arm and a distal end connected to the trailing arm, the ends of the shock absorber being resiliently movable towards one another so as damp pivoting of the trailing arm relative to the main arm; and
an adjustment member arranged to couple an end of the shock absorber to the corresponding arm,
wherein the method comprises:
accelerating the aircraft to take-off speed; and
moving the adjustment member from a second position to a first position to move said end of the shock absorber relative to said arm, thereby allowing and/or driving the trailing arm to pivot relative to the main arm from a second angle to a first angle and thus changing the angle of attack of the aircraft.

24. The method according to claim 23 wherein the adjustment member is moved to the first position by operating an elevator of the aircraft so as to change the force exerted on the landing gear by the ground.

25. The method according to claim 23, wherein the adjustment member is moved to the first position by an adjuster.

26. The method according to claim 25, wherein the adjuster is configured to move the adjuster to a first position, and the adjuster is a hydraulic cylinder pre-pressurised prior to movement of the adjustment member to a first position.

27. The method according to claim 24, wherein the adjustment member is moved to the first position against the action of an adjuster.
